(19) United States
(12) Patent Application Publication
(10) Pub. No.: US 2005/0057558 A1
(43) Pub. Date: Mar. 17, 2005

(54) Display device and its synchronized signal detecting device and detecting method

(75) Inventor: Kwang-Whui Cho, Yongin-si (KR)

Correspondence Address: Steven M. Mills;MILLS & ONELLO LLP, Suite 605, Eleven Beacon Street, Boston, MA, 02108, US

(73) Assignee: Samsung Electronics Co., Ltd.

(21) Appl. No.: 10/935,888

(22) Filed: Sep. 8, 2004

(30) Foreign Application Priority Data
Sep. 16, 2003 (KR) 03-64145

(51) Int. Cl. G09G 5/00

(52) U.S. Cl. 345/213

(57) ABSTRACT

In a display device and its synchronizing signal detecting device and a detecting method, an image separation signal and a SOG separation signal are separated from an inputted image signal, and then whether a period variation of the separated signal is under a reference period variation and whether a ground section of the separated signal is under a reference time are determined. As a result, whether the separated signal is the image separation signal or the SOG separation signal is exactly detected. As a result, normal operation of the display device is achieved irrespective of DPM mode.

### RELATED APPLICATION

The present application relies for priority on Korean patent application number 2003-64145, filed in the Korean Intellectual Property Office on Sep. 16, 2003, the contents of which are incorporated herein in their entirety by reference.

### FIELD OF THE INVENTION

The present invention is related to display devices, and, in particular, to a synchronizing signal detecting device of a display device and a detecting method.

### BACKGROUND OF THE INVENTION

Display devices display image signals transferred from graphic cards of computers to screens as image pictures through a series of signal processes. Recently, display devices have been used in the field of monitors using cathode ray tube (CRT), LCD suitable to large scale monitors, etc.

FIG. 1 is a schematic block diagram of a conventional display device.

Referring to FIG. 1, the conventional display device comprises a graphic card 10 for generating image signals R, G and B, and a synchronizing signal; a synchronizing signal detection unit 20 for generating a vertical synchronizing signal and a horizontal synchronizing signal H/V by separating a synchronizing signal from a G image signal from the graphic card 10; an image signal processing unit 30 for receiving the image signals R,G and B from the graphic card 10 in response to the detected synchronizing signal and then processing an image signal such as a primary amplification and OSD mix, a contrast control; a display device 40 for displaying the processed image signal on screens as an image picture; and a MICOM 50 for controlling the display device according to a detection mode signal MODE inputted from the synchronizing detection unit 20.

In this display device, if the G image signal is applied under the condition that the horizontal synchronizing signal Hsync and the vertical synchronizing signal Vsync or a composite synchronizing signal Csync do not exist, and at the same time a SOG (Sync On Green) signal also does not exist, the synchronizing detection unit 20 may mis-detect that there is a synchronizing signal by recognizing the G image signal as the SOG signal. That is, irrespective of a DPM (Display Power Management) mode without the synchronizing signal, there is a serious error in normal operation of the display device caused by mis-detecting the G image signal as the synchronizing signal.

If the horizontal synchronizing signal Hsync and the vertical synchronizing signal Vsync are not applied to monitors, the DPM mode detects that the monitors are not used. As a result, the DPM supplies power to only necessary components for action standby of the MICOM in the monitors and breaks power to components consuming high power.

If the G image signal is applied under the condition that the horizontal synchronizing signal Hsync and the vertical synchronizing signal Vsync or a composite synchronizing signal Csync are not applied, the synchronizing signal detection unit 20 detects whether the G image signal is the SOG signal.

After separating an image signal inputted from the graphic card 10 into an image separation signal or a SOG separation signal, the synchronizing signal detection unit 20 detects whether the separated signal is an image separation signal or the SOG separation signal. If the separated signal is the SOG separation signal, the synchronizing signal detection unit 20 detects the horizontal synchronizing signal and the vertical synchronizing signal H/V.

The image signal processing unit 30 receives the detected synchronizing signal H/V from the synchronizing signal detection unit 20, and then performs image signal R, G and B processing (e.g., an OSD mix, a contrast control). The display device 40 displays an image picture on screens according to the processed image signal and synchronizing signal. Also, the MICOM 50 generates a signal process control signal equivalent to a mode signal.

However, since the waveform of the image separation signal is similar to that of the SOG separation signal in detecting the synchronizing signal, there is a potential to incorrectly recognize the image separation signal as the SOG separation signal. That is, irrespective of inputting the image signal, there is a serious error in normal operation of the display device by mis-detecting there is a synchronizing signal. That is, irrespective of a DPM (Display Power Management) mode without the synchronizing signal, there is a serious error in normal operation of the display device by mis-detecting the G image signal as the synchronizing signal.

A method to overcome these problems is disclosed in Korean Patent Application No. 10-1999-0005349. The approach described in that application employs a method by which, if a signal inputted to the synchronizing signal detection unit 20 is the SOG signal, an input voltage level is 1Vp-p (Peak to Peak), and if a signal inputted to the synchronizing signal detection unit 20 is the image signal, an input voltage level is 0.7 Vp-p (Peak to Peak). That is, if the input voltage level is higher than the reference voltage by adopting the reference voltage as 0.7Vp-p, the SOG signal is detected. If the input voltage level is lower than the reference voltage, the image signal is detected.

However, there is a drawback to the approach disclosed in the above patent application. For example, if the image picture of the SOG signal is dark, i.e., close to black, a voltage level may be under 0.7Vp-p. That is, if the input voltage level of SOG signal is under 0.7Vp-p, the synchronizing signal detection unit may mis-detect that there is a G image signal irrespective of the SOG signal.

### SUMMARY OF THE INVENTION

It is therefore a feature of the invention to provide a detecting device capable of exactly detecting whether any signal of an image signal and a SOG signal is inputted and a method for the same.

A synchronizing signal detecting device in accordance with the invention comprises an image signal separation unit and a separated signal decision unit. The image signal separation unit separates a signal under a sense level from an inputted image signal, and the separated signal decision unit detects whether the separated signal includes a synchronizing signal.

In accordance with one aspect of a display system according to the present invention, the display system comprises a display device; an image signal separation unit for separating a signal under a sense level from an inputted image signal; a separated signal decison unit for determining whether a ground section of the separated signal is under a reference time and generating a mode signal; and a MICOM controlling an operation mode of the display device in response to the mode signal.

In one embodiment, the reference time is within the range of the sum of a front porch time and a back porch time of a SOG separation signal.

In one embodiment, if the ground section of the separated signal exceeds the reference time, an abnormal mode signal is outputted.

In accordance with another aspect of the present invention, the display system comprises a display device; an image signal separation unit for separating a signal under a sense level from an inputted image signal; a separated signal decision unit for determining whether a period variation of the separated signal is under a reference period variation and a ground section of the separated signal is under a reference time, and thereby generating a mode signal; and a MICOM for controlling an operation mode of the display device in response to the mode signal.

In one embodiment, the reference time is within the range of the sum of a front porch time and a back porch time of a SOG separation signal.

In one embodiment, if the period variation of the separated signal exceeds the reference period variation, an abnormal mode signal is outputted.

In one embodiment, if the ground section of the separated signal exceeds the reference time, an abnormal mode signal is outputted.

In accordance with another aspect, the invention is directed to a method for detecting a synchronizing signal. The method includes the steps of: separating a signal under a sense level from an inputted image signal; and determining whether the separated signal includes a synchronizing signal.

In accordance with another aspect, the invention is directed to another method for detecting a synchronizing signal. The method includes the steps of: separating a signal under a sense level from an inputted image signal; determining whether a ground section of the separated signal is under a reference time; and outputting a normal mode signal if the ground section is under the reference time.

In one embodiment, the reference time is within the range of the sum of a front porch time and a back porch time of a SOG separation signal.

In one embodiment, if the ground section of the separated signal exceeds the reference time, an abnormal mode signal is outputted.

In accordance with still another aspect, the invention is directed to another method for detecting a synchronizing signal. The method comprises separating a signal under a sense level from an inputted image signal; determining whether a period variation of the separated signal is under a reference period variation; determining whether the ground section of the separated signal is under the reference time if the period variation is under the reference period variation; and outputting a normal mode signal if the ground section is under the reference time.

In one embodiment, the reference time is within the range of the sum of a front porch time and a back porch time of a SOG separation signal.

In one embodiment, if the period variation of the separated signal exceeds the reference period variation, an abnormal mode signal is outputted.

In one embodiment, if the ground section of the separated signal exceeds the reference time, an abnormal mode signal is outputted.

In accordance with another aspect, the invention is directed to a synchronizing signal detecting device. The device includes an image signal separation unit for separating a signal under a sense level from an inputted image signal. A separated signal decision unit determines whether the separated signal includes a synchronizing signal.

### BRIEF DESCRIPTION OF THE DRAWINGS

The foregoing and other features and advantages of the invention will be apparent from the more particular description of an embodiment of the invention, as illustrated in the accompanying drawing. The drawing is not necessarily to scale, emphasis instead being placed upon illustrating the principles of the invention.

FIG. 1 is a schematic block diagram showing a conventional display device.

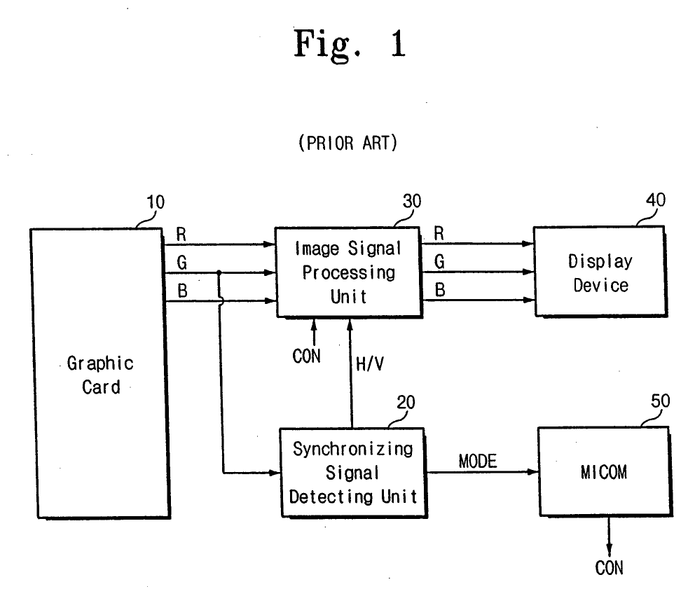

FIG. 2 is a schematic block diagram of an embodiment of a synchronizing signal detecting device according to the present invention.

FIG. 3 is a flowchart of a first embodiment of a method for detecting a synchronizing signal according to the present invention.

FIG. 4 is a flowchart of a second embodiment of a method for detecting a synchronizing signal according to the present invention.

FIG. 5 is a waveform diagram illustrating a period variation of an image signal and a separation signal.

FIG. 6 is a waveform diagram illustrating a difference of a ground section of an image signal and a separation signal.

### DESCRIPTION OF THE PREFERRED EMBODIMENT

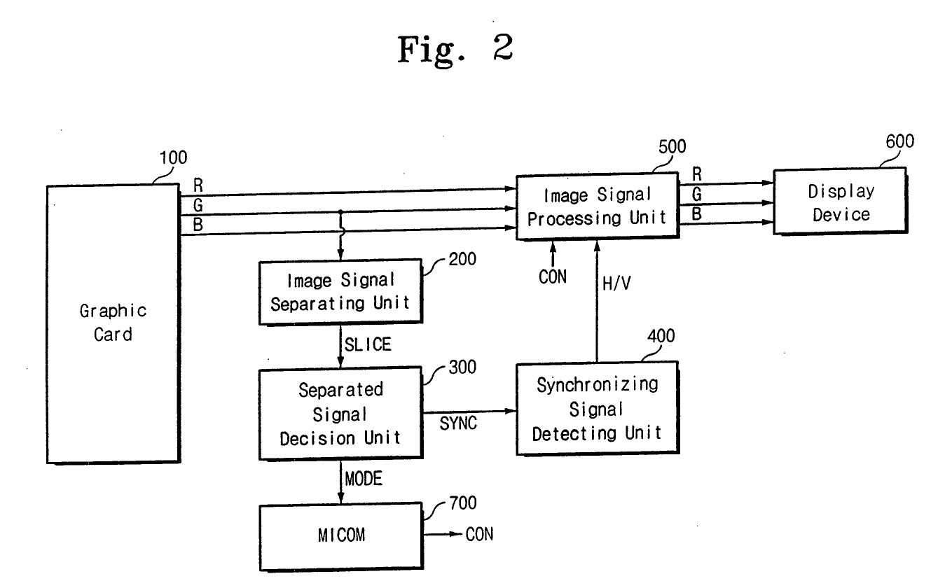

FIG. 2 is a schematic block diagram of an embodiment of a synchronizing signal detecting device according to the present invention.

A synchronizing signal detecting device according to the present invention comprises an image signal separation unit 200 for separating a signal under a sense level from an inputted image signal; and a separated signal decision unit 300 for determining whether the separated signal includes a synchronizing signal or not.

According to the first embodiment of the present invention, a display system comprises a display device; an image signal separation unit 200 for separating a signal under a sense level from an inputted image signal; a separated signal decision unit 300 for determining whether a ground section of the separated signal is under a reference time to generate a mode signal; and a MICOM 700 for generating a signal controlling an operation mode of a display device in response to the mode signal. In this case, the reference time is within the range of the sum of a front porch time and a back porch time of a SOG separation signal.

According to the second embodiment of the present invention, a display system comprises a display device; an image signal separation unit 200 for separating a signal under a sense level from an inputted image signal; a separated signal decision unit 300 for determining whether a period variation of the separated signal is under a reference period variation and whether a ground section of the separated signal is under a reference time, and then generating a mode signal; and a MICON for generating a signal controlling an operation mode of the display device in response to the mode signal. In this case, the reference time is within the range of the sum of a front porch time and a back porch time of a SOG separation signal.

Referring to FIG. 2, a graphic card 100 generates a synchronizing signal (e.g., a SOG signal) for loading and transferring the image signal (e.g., a G image signal) to image signals R, G, and B, and a synchronizing signal. In order to meet standard requirements of manufacturing companies, the graphic card 100 generates signals according to a regular pattern, that is, a horizontal synchronizing signal Hsync, a vertical synchronizing signal Vsync and a composite synchronizing signal Csync, or a SOG (Sync On Green) signal. The SOG signal loads and transfers a G image signal to the composite synchronizing signal Csync. Accordingly, a signal removing the G image signal from the SOG signal is equal to the composite synchronizing signal Csync.

The image signal separation unit 200 separates an image signal (e.g., a G image signal) inputted from the graphic card 100 under a sense level to generate a separation signal. The image signal (e.g., a G image signal) inputted from the graphic card 100 may be the G image signal itself or a SOG signal loading a G image to the composite synchronizing signal Csync.

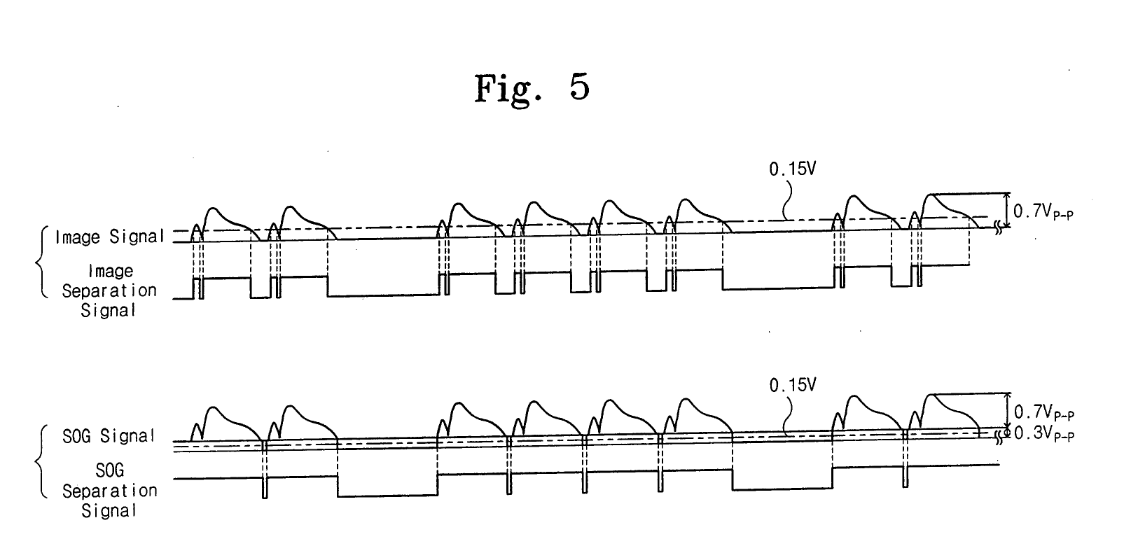

FIG. 5 is a waveform diagram of a voltage level of an image signal or a SOG signal, and a voltage level of an image separation signal and a SOG separation signal. If an image signal or the SOG signal is inputted from the graphic card 100 to the image signal separation unit 200, they are separated under a sense level (e.g., 0.15V) to generate the image separation signal and the SOG signal.

In FIG. 5, the image signal is a G image signal and an analog signal of 0.7 Vp-p. If the image signal is inputted to the image signal separation unit 200, as shown in FIG. 5, a signal under a sense level (e.g., 0.15V) is outputted “low”, and a signal over the sense level (e.g., 0.15V) is outputted “high”, and thereby generating the image separation signal. The image separation signal is a digital signal.

The SOG signal is an analog signal of 1Vp-p where a G image signal is loaded to the composite synchronizing signal Csync. In FIG. 5, the G image signal is an analog signal of 0.7Vp-p, and the composite synchronizing signal is an analog signal of 0.3Vp-p. In order to generate a SOG separation signal, the SOG signal is separated under a sense level (e.g., 0.15V). A signal under the sense level (e.g., 0.15V) is outputted “high”, and thereby generating a SOG separation signal. The SOG separation signal is a digital signal.

In FIG. 5, only four horizontal signals are in one frame of the SOG signal. However, a lot of the horizontal signals exist in one frame.

The separated signal decision unit 300 receives an image separation signal inputted from the image signal separation unit 200 and a SOG signal. The separated signal decision unit 300 determines whether the inputted separation signal includes a synchronizing signal. The synchronizing signal is included in the image separation signal, but the composite synchronizing signal is included in the SOG separation signal. The object of the present invention is to prevent error in determining that the synchronizing signal is included although the image separation signal does not include the synchronizing signal. In order to remove this error, it is exactly determined whether the separated signal is an image signal or a SOG signal.

A standard of judgment is a period variation of the image separation signal and the SOG separation signal, and a length of a ground section. That is, the image signal separation unit 200 determines whether the period variation of the separated signal is under a reference period variation and/or whether the ground section of the separated signal is under a reference time.

The standard of judgment depends on the following characteristics. First, a signal by which a G image signal is removed in a SOG signal is typically equal to a composite synchronizing signal. Second, an image separation signal has a long ground section as much as the total time of a front porch time and a back porch time. According to these characteristics, it is possible to exactly determine whether any one synchronizing signal of the image separation signal and the SOG separation signal is inputted to the separated signal decision unit 300.

A period variation of the separated signal is measured during a specified period of time (generally, more than 1 frame). As a result, if the period variation is under a reference period variation, a SOG signal is determined, and to the contrary, if the period variation is over the reference period variation, the image separation signal is determined. This employs the above former characteristic. Referring to FIG. 5, there are two period variations in the SOG separation signal. First, the period is varied in a section by which the horizontal synchronizing signal is changed to the vertical synchronizing signal during one frame. Second, the period is varied in a section by which the vertical synchronizing signal is changed to the horizontal synchronizing signal. However, since the image signal is an analog signal with change of amplitude, the amplitude of the image separation signal becomes dramatically changed during 1 frame. Accordingly, after pre-setting the number of the reference period variation (e.g., four times), if the period variation of the separated signal is under the reference period variation, a SOG signal is determined. To the contrary, if the period variation of the separated signal is over the reference period variation, an image separation signal is determined.

According to the method using the period variation, in the case in which an image signal is repeated every regular period or a well-lighted image like white, it has a regular period like a SOG separation signal, so that there is a disadvantage of incorrectly determining the image separation signal as the SOG signal.

In order to prevent these problems, the image signal and the SOG signal are determined using the length of a ground section in the present invention. In one embodiment, this method assumes that an image separation signal has long ground section as much as the total time of a front porch time and a back porch time.

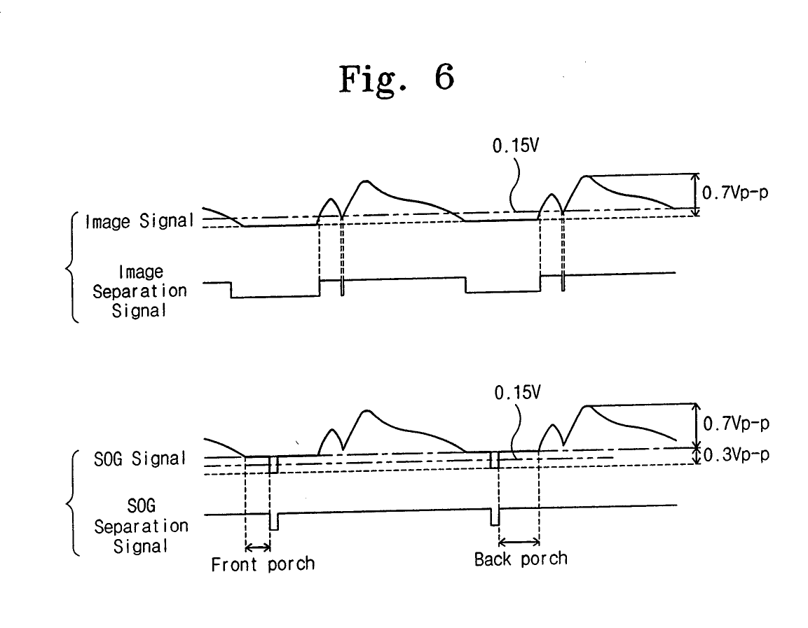

Referring to FIG. 6, if a SOG signal separated from the image signal separation unit 200 is compared with a ground section of an image separation signal, the ground section of the image separation signal has a duration as long as the total time of a front porch time and a back porch time. In particular, a front porch section and a back porch section of the vertical synchronizing signal Vsync during 1 frame is markedly long in comparison with the ground section of the SOG separation signal.

Therefore, a reference time is set to an adequate value in the range of total sum of a front porch time and a back porch time of the SOG separation signal. If the time of the ground section of the separated signal is under the reference time, a SOG signal is determined. On the contrary, if the time of the ground section of the separated signal is over the reference time, an image separation signal is determined.

Referring to FIG. 2 again, the separated signal decision unit 300 determines whether the separation signal is the image separation signal or the SOG separation signal. If the separation signal is the SOG signal, it is the composite synchronizing signal Csync. As a result, the separation signal is transferred to the synchronizing signal detection unit 400, and a normal mode signal is transferred to the MICOM 700. If the separated signal is an image separation signal, the separated signal is not a synchronizing signal, so that an abnormal mode signal is transferred to the MICOM 700.

The synchronizing signal detection unit 400 receives a SOG separation signal inputted from the separated signal decision unit 300, that is, a composite synchronizing signal Csync. The synchronizing signal detection unit 400 receives the composite synchronizing signal Csync from the separated signal decision unit 300 to detect the horizontal synchronizing signal and the vertical synchronizing signal H/V. The detected synchronizing signals H/V are applied to an image signal processing unit 500.

Various image processes (e.g., scaling, OSD (On Screen Display), gamma correction, color enhancement, etc.) are performed in the image signal processing unit 500 using the image signals R, G and B, and the synchronizing signals (the horizontal synchronizing signal and the vertical synchronizing signal). Then, the image-processed image signals R, G and B are transferred to a display device 600. The display device 600 displays an image.

The MICOM 700 generates a system control signal CON so as to perform an applicable signal processing operation according to a normal mode signal or an abnormal mode signal, which are outputted from the separated signal decision unit 300. By these operations, the MICOM 700 controls various kinds of functions of the display device. In case that an operation mode is the abnormal mode, the MICOM 700 supplies power to only necessary components for action standby. In addition, the MICOM breaks power to the rest of the components such as components consuming high power.

A method of detecting a synchronizing signal according to the present invention comprises the steps of: separating a signal under a sense level from an inputted image signal; and determining whether the separated signal includes a synchronizing signal.

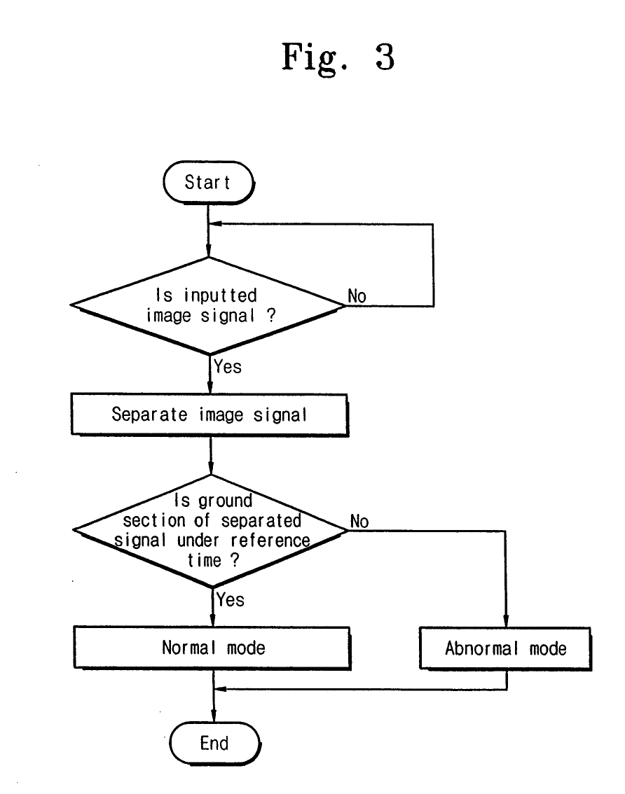

FIG. 3 is a flowchart of the first embodiment of a method for detecting a synchronizing signal according to the present invention. In another aspect of the present invention, the method for detecting a synchronizing signal comprises the steps of: separating a signal under a sense level from an inputted image signal; determining whether a ground section of the separated signal is under a reference time; and outputting a normal mode signal if the ground section is under the reference time. In this case, the reference time is in the range of total sum of a front porch time and a back porch time of a SOG separation signal.

Referring to FIG. 3, in the first step, whether an image signal is inputted during a regular time (more than 1 frame) is determined. If the image signal exists, the process advances to the second step. If the image signal does not exist, the first step is repeated.

In the second step, the image signal inputted from the image signal separation unit 200 is separated under a sense level. The separated signal becomes digitalized.

In the third step, the time of a ground section of the separated signal during a regular time (more than 1 frame) is determined. If the ground section of the separated signal is under a reference time, a SOG separation signal is determined, and then the next step is performed. If the ground section exceeds a reference time, an image separation signal is determined, and then an abnormal mode step is performed.

As shown in FIG. 6, these operations assume that the ground section of the image separation signal is as long as much as sections of a front porch and a back porch in comparison with the ground section the SOG separation signal. Specifically, a front porch section and a back porch section of the vertical synchronizing signal Vsync during 1 frame is markedly long in comparison with the ground section of the SOG separation signal.

Therefore, a reference time is set to an adequate value in the range of the total sum of a front porch time and a back porch time of the SOG separation signal. If the time of the ground section of the separated signal is under the reference time, a SOG signal is determined. On the contrary, if the time of the ground section of the separated signal is over the reference time, an image separation signal is determined.

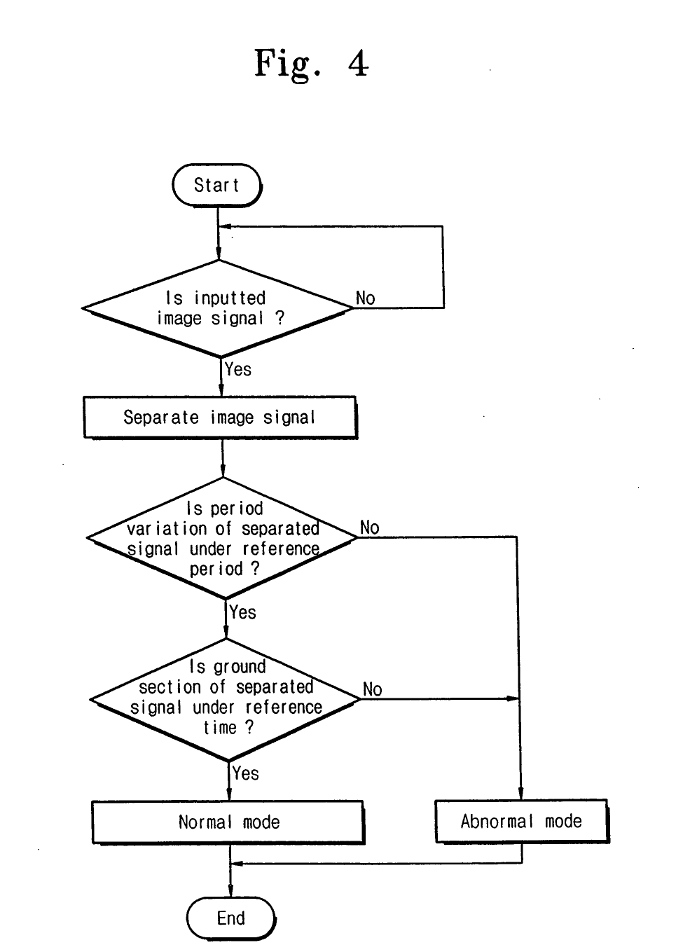

FIG. 4 is a flowchart showing the second embodiment of a method for detecting a synchronizing signal in accordance with the present invention. In still another aspect of the present invention, the method for detecting the synchronizing signal comprises the steps of: separating a signal under a sense level from an inputted image signal; determining whether a period variation of the separated signal is under a reference period variation; determining whether a ground section of the separated signal is under a reference time if the period variation is under the reference period variation; and outputting a normal mode signal if the ground section is under the reference time. In this case, the reference time is in the range of total sum of a front porch time and a back porch time.

Referring to FIG. 4, in the first step, whether an image signal is inputted during a regular time (more than 1 frame) is determined. If the image signal exists, the process advances to the second step. If the image signal does not exist, the first step is repeated.

In the second step, the image signal inputted from the image signal separation unit 200 is separated under a sense level. The separated signal becomes digitalized.

In the third step, a period variation of the separate signal during a regular time (more than 1 frame) is determined. If the period variation of the separated signal is under a reference period variation, the fourth step is performed. In case that the period variation of the separated signal exceeds the reference period variation, an abnormal mode step is performed.

As shown in FIG. 5, these operations assume that a signal by which a G image signal is removed from a SOG signal is equal to the composite synchronizing signal Csync. That is, there are two period variations in the SOG separation signal. First, the period is varied in a section by which the horizontal synchronizing signal is changed to the vertical synchronizing signal during one frame. Second, the period is varied in a section by which the vertical synchronizing signal is changed to the horizontal synchronizing signal. However, since the image signal is an analog signal with many changes of amplitude, the amplitude of the image separation signal becomes dramatically changed during 1 frame. Accordingly, after pre-setting the number of the reference period variation (e.g., four times), if the period variation of the separated signal is under the reference period variation, a SOG signal is determined and then the fourth step is performed. On the contrary, if the period variation of the separated signal exceeds the reference period variation, an image separation signal is determined, and the abnormal mode step is performed.

In the case in which an image signal is repeated every regular period or a well-lighted image like white, it has a regular period like a SOG separation signal, so that there is a disadvantage of incorrectly determining the image separation signal as the SOG signal. In order to prevent these errors, when the ground section exceeds the reference time, the image separation signal is determined, and then the abnormal mode signal is performed.

As shown in FIG. 6, these operations assume that the ground section of the image separation signal is as long as much as sections of a front porch and a back porch in comparison with the ground section the SOG separation signal. Specifically, a front porch section and a back porch section of the vertical synchronizing signal Vsync during 1 frame is markedly long in comparison with the ground section of the SOG separation signal.

Therefore, a reference time is set to an adequate value in the range of a total sum of a front porch time and a back porch time of the SOG separation signal. If the time of the ground section of the separated signal is under the reference time, a SOG signal is determined. On the contrary, if the time of the ground section of the separated signal is over the reference time, an image separation signal is determined.

According to the present invention, it is possible to exactly determine whether the separated signal is the image separation signal or the SOG separation signal or not. If the SOG signal is determined, a signal processing operation equivalent to a normal mode is performed, and thereby normally operating the display device. Unlike this, if the image separation signal is determined, a signal processing operation equivalent to an abnormal mode is performed, so that display device is not operated. For this reason, it is possible to prevent a display device from being normally operated irrespective of DPM mode.

While this invention has been particularly shown and described with reference to preferred embodiments thereof, it will be understood by those skilled in the art that various changes in form and details may be made therein without departing from the spirit and scope of the invention as defined by the appended claims.

1. A method for detecting a synchronizing signal comprising:
separating a signal under a sense level from an inputted image signal; and
determining whether the separated signal includes a synchronizing signal.

2. A method for detecting a synchronizing signal comprising:
separating a signal under a sense level from an inputted image signal;
determining whether a ground section of the separated signal is under a reference time; and
outputting a normal mode signal if the ground section is under the reference time.

3. The method of claim 2, wherein the reference time is within the range of the sum of a front porch time and a back porch time of a SOG separation signal.

4. The method of claim 2, wherein if the ground section of the separated signal exceeds the reference time, an abnormal mode signal is outputted.

5. A method for detecting a synchronizing signal comprising:
separating a signal under a sense level from an inputted image signal;
determining whether a period variation of the separated signal is under a reference period variation;
determining whether the ground section of the separated signal is under the reference time if the period variation is under the reference period variation; and
outputting a normal mode signal if the ground section is under the reference time.

6. The method of claim 5, wherein the reference time is within the range of the sum of a front porch time and a back porch time of a SOG separation signal.

7. The method of claim 5, wherein if the period variation of the separated signal exceeds the reference period variation, an abnormal mode signal is outputted.

8. The method of claim 5, wherein if the ground section of the separated signal exceeds the reference time, an abnormal mode signal is outputted.

9. A synchronizing signal detecting device comprising:
an image signal separation unit for separating a signal under a sense level from an inputted image signal; and
a separated signal decision unit for determining whether the separated signal includes a synchronizing signal.

10. A display system comprising:
a display device;
an image signal separation unit for separating a signal under a sense level from an inputted image signal;
a separated signal decision unit for determining whether a ground section of the separated signal is under a reference time and generating a mode signal; and
a MICOM for controlling an operation mode of the display device in response to the mode signal.

11. The display system of claim 10, wherein the reference time is within the range of the sum of a front porch time and a back porch time of a SOG separation signal.

12. The display system of claim 10, wherein if the ground section of the separated signal exceeds the reference time, an abnormal mode signal is outputted.

13. A display system comprising:
a display device;
an image signal separation unit for separating a signal under a sense level from an inputted image signal;
a separated signal decision unit for determining whether a period variation of the separated signal is under a reference period variation and a ground section of the separated signal is under a reference time, and thereby generating a mode signal; and
a MICOM for controlling an operation mode of the display device in response to the mode signal.

14. The display system of claim 13, wherein the reference time is within the range of the sum of a front porch time and a back porch time of a SOG separation signal.

15. The display system of claim 13, wherein if the period variation of the separated signal exceeds the reference period variation, an abnormal mode signal is outputted.

16. The display system of claim 13, wherein if the ground section of the separated signal exceeds the reference time, an abnormal mode signal is outputted.
